(19) United States
(12) Patent Application Publication
(10) Pub. No.: US 2010/0296279 A1
(43) Pub. Date: Nov. 25, 2010

(54) TABLE LAMP WITH AN ADJUSTABLE PROJECTING AREA

(76) Inventor: Hun-Yuan Ko, Taipei County (TW)

Correspondence Address: Chien-Hui Su, P. O. Box 70-121 Taichung, Taichung City, 40899, TW

(21) Appl. No.: 12/471,461

(22) Filed: May 25, 2009

(51) Int. Cl. F21V 9/00; F21V 1/00

(52) U.S. Cl. 362/231; 362/235

(57) ABSTRACT

A table lamp with an adjustable projecting area includes an illuminator. The illuminator has a diffuser detachably mounted on one side thereof and at least one fastening means disposed thereon corresponding to the diffuser for selectively fastening the diffuser on the illuminator. At least one lamp is received in the illuminator for emitting lights. The at least one lamp is provided for a spotlighting function and covered by the diffuser.

### BACKGROUND OF THE INVENTION

1. Field of the Invention

The present invention relates to a table lamp, and more particularly to a table lamp with an adjustable projecting area.

2. Description of Related Art

A retina has two different kinds of optic cells, including cone cells and rod cells. The amount of the cone cells and the rod cells is about one hundred sixty million to one hundred eighty million. The function of the cone cells is to differentiate colors and to distinguish details of a vision. The function of the rod cell is to identify the light and the shade.

A traditional table lamp is used a tungsten lamp or a mercury vapor lamp as an emitting source thereof. However, a power consumption of the tungsten lamp is high such that the cost is high. The mercury vapor lamp is easily flickered such that the eyes are damaged. Therefore, a conventional table lamp is presented. The conventional table lamp comprises a circuit. The circuit has multiple light-emitting diodes (LEDs) mounted on a bottom thereof. A transparent plate is mounted on the bottom of the circuit and covered the multiple LEDs. The transparent plate has multiple arc ribs formed thereon for focusing lights emitted from the multiple LEDs. The arc ribs are parallel to each other.

However, each LED is a spotlight. The lights focused by the multiple arc ribs are alternately formed multiple bright stripes and multiple dark stripes. The optical cells of the retina are irritated due to the multiple bright stripes and the multiple dark stripes. Furthermore, different environment have different illumination requirements. When reading, a focused soft illumination is required. When typing in front of a screen, a wide and less illumination is required. The conventional table lamp is not adjustable for suiting the different illumination requirements.

The present invention has arisen to mitigate and/or obviate the disadvantages of the conventional table lamp.

### SUMMARY OF THE INVENTION

The main objective of the present invention is to provide an improved table lamp with an adjustable projecting area.

To achieve the objective, a table lamp with an adjustable projecting area in accordance with the present invention comprises an illuminator, multiple lamps mounted in the illuminator, and a diffuser detachably mounted on the illuminator. The multiple lamps are positioned for corresponding to diffuser. The illuminator has two dove-tail grooves defined in a bottom of the illuminator. Two ends of the diffuser are respectively detachably and slidably received in the two dove-tail grooves. The diffuser is pervious. The diffuser has a scattering layer formed on one side thereof. The scattering layer has multiple particles formed therein for uniformly diffusing light emitted by the multiple lamps. The diffuser has multiple optical protrusions formed on a bottom thereof. Each optical protrusion has a specific curvature provided for refracting the lights diffused by the scattering layer.

In accordance with another aspect of the present invention, the illuminator has multiple pivotal sheets respectively pivotally mounted on the bottom of the illuminator. The multiple pivotal sheets are disposed on corners and edges of the illuminator for selectively locking the diffuser.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a table lamp with an adjustable projecting area in accordance with the present invention;

FIG. 2 is an enlarged exploded view of an illumination of the table lamp with an adjustable projecting area in accordance with the present invention;

FIG. 3 is an enlarged perspective view of the illumination of the table lamp with an adjustable projecting area in accordance with the present invention;

FIG. 4-5 are enlarged partial plane views of the illumination of the table lamp with an adjustable projecting area in accordance with the present invention, showing that different multiple lamps;

FIG. 6 is an enlarged partial side plane view of a diffuser of the table lamp with an adjustable projecting area in accordance with the present invention;

FIG. 7-8 are operational views of the table lamp with an adjustable projecting area in accordance with the present invention, showing that different projecting areas in different environmental requirement; and

FIG. 9 is an enlarged perspective view of an illumination of a second embodiment of the table lamp with an adjustable projecting area in accordance with the present invention.

### DETAILED DESCRIPTION OF THE INVENTION

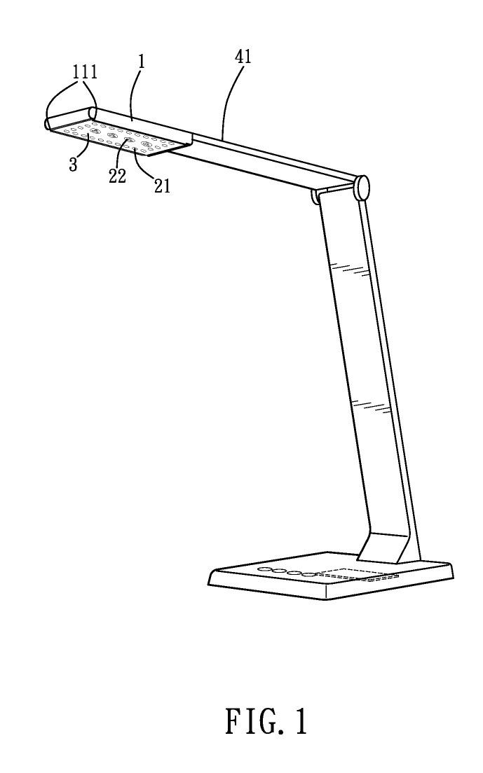

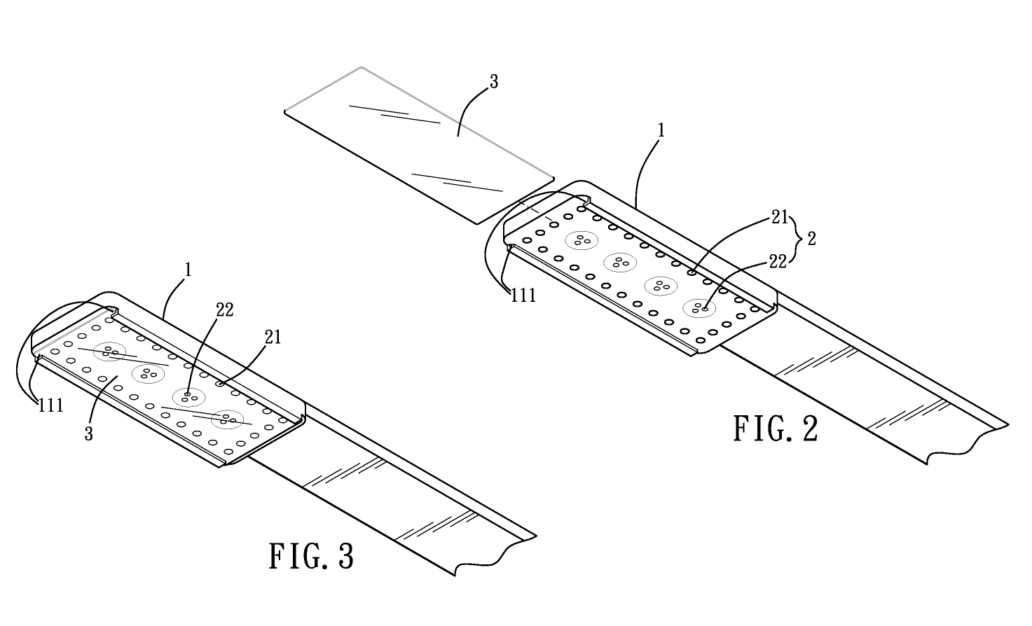

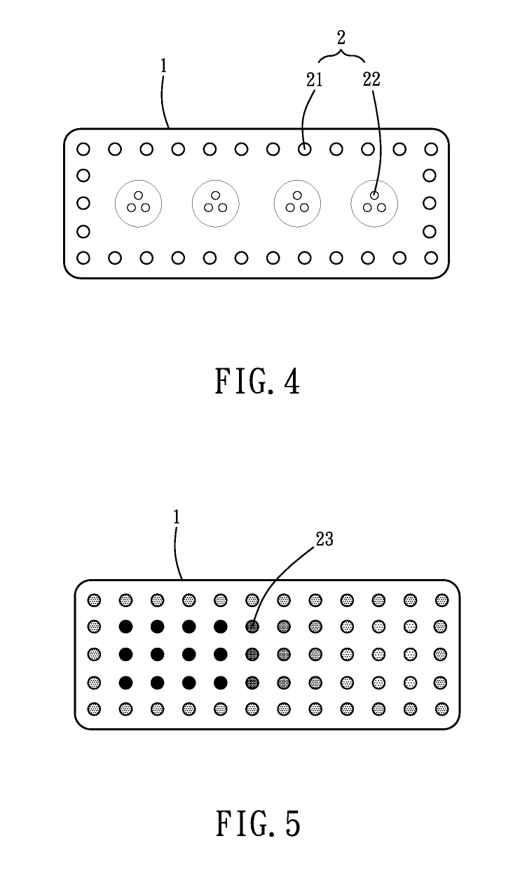

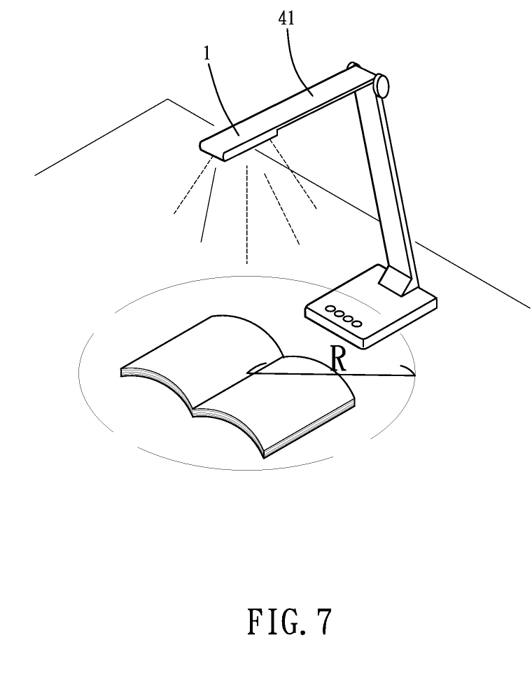

Referring to the drawings and initially to FIGS. 1-8, a table lamp with an adjustable projecting area in accordance with the present invention comprises an arm 41 extended therefrom, an illuminator 1 mounted on one end of the arm 41, multiple lamps 2 mounted in the illuminator 1, and a diffuser 3 detachably mounted on the illuminator 1.

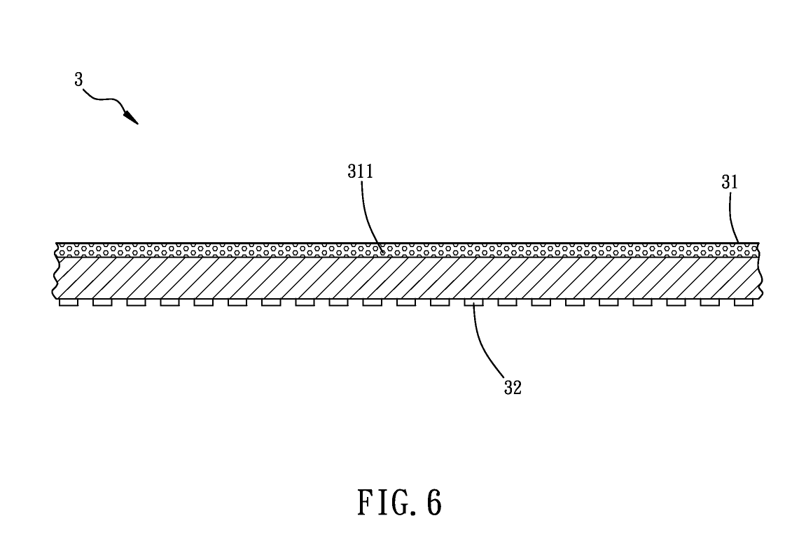

The arm 41 is pivotable for adjusting a position of the illuminator 1. The multiple lamps 2 are positioned for corresponding to diffuser 3. The multiple lamps 2 are provided for emitting lights. Each lamp 2 is provided for a spotlighting function. The lights emitted by the multiple lamps 2 pass through the diffuser 3. The multiple lamps 2 can be multiple white LEDs 21 and multiple RGB LEDs 22 as shown in FIG. 4. The multiple RGB LEDs 22 are linearly arranged in a middle of the illuminator 1 such that the white LEDs 21 are surroundingly arranged relative to RGB LEDs 22 to provide a illumination and a color temperature. The multiple lamps 2 can be multiple color temperature LEDs 23 for emitting lights having different color temperatures as shown in FIG. 5. The illuminator 1 has two dove-tail grooves 111 respectively defined in two side of a bottom of the illuminator 1. The two dove-tail grooves 111 are parallel to each other. The two dove-tail grooves 111 are faced to each other for positing the diffuser 3. The diffuser 3 has a plate structure and covers the multiple lamps 2. Two ends of the diffuser 3 are respectively detachably and slidably received in the two dove-tail grooves 111. The diffuser 3 is pervious. The diffuser 3 has a scattering layer 31 formed on one side thereof. The scattering layer 31 is pervious. The scattering layer 31 has multiple optical particles 311 formed therein for uniformly diffusing light emitted by the multiple lamps 2. The multiple optical particles 311 can be formed of plastic particles or polyester particles. The diffuser 3 has multiple optical protrusions 32 formed on a bottom thereof opposite to the multiple lamps 2. The multiple optical protrusions 32 are pervious. Each optical protrusion 32 has a specific curvature provided for refracting the lights diffused by the scattering layer 31. When the two ends of the diffuser 3 is respectively slidably received in the two dove-tail grooves 111 and the multiple lamps 2 are covered by the diffuser 3, the lights emitted by the multiple lamps 2 are diffused by the scattering layer 31 and refracted by the multiple optical protrusions 32 such that a lighting projecting area of the multiple lamps 2 is adjusted by the diffuser 3. The spotlighting function of the multiple lamps 2 is transformed into a diffused flat light function to prevent the lights from overly concentrating. The diffuser 3 is detachable such that the diffuser 3 is replaced with different diffusers 3 having different curvatures for adjusting the projecting area to suit different requirements.

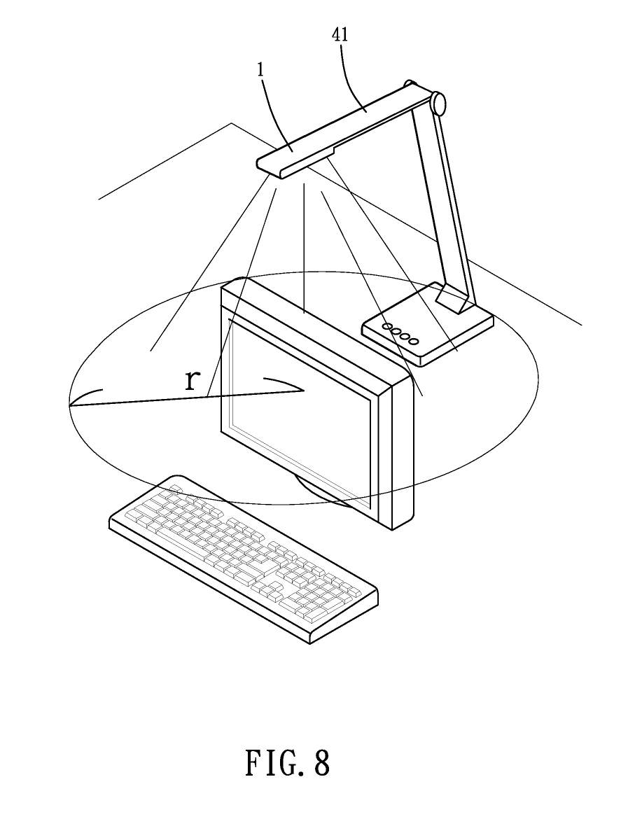

When a user is in reading, as shown in FIG. 7, a focused illumination is required such that the projecting area of the illuminator 1 has a first radius R. When the user is in typing in front of a computer, a wide illumination is required such that the diffuser 3 is detached and replaced to another diffuser 3 having a wide curvature. The projecting area of the illuminator 1 has a second radius r and the second radius r is greater than the first radius R. The diffuser 3 is detached and is replaceable for adjusting the projecting areas based on different environmental requirements.

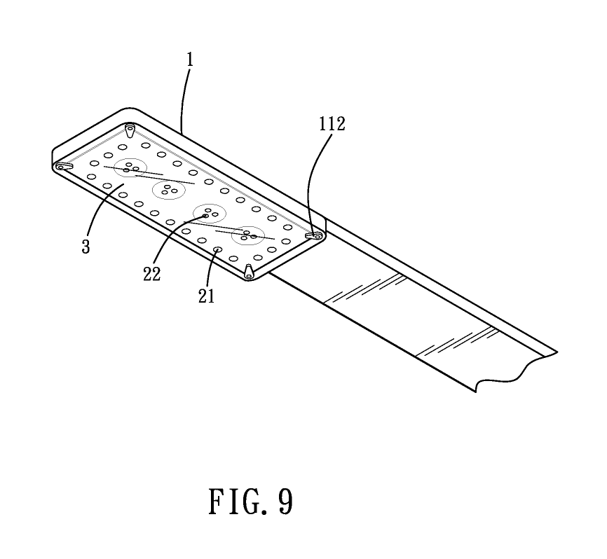

With reference to FIG. 9, that shows a second embodiment of the table lamp with an adjustable projecting area of the present invention. The elements and effects of the second embodiment which are the same with the first embodiment are not described, only the differences are described. The illuminator 1 has multiple pivotal sheets 112 respectively pivotally mounted on the bottom of the illuminator 1. The multiple pivotal sheets 112 are disposed on corners and edges of the illuminator 1. When the multiple pivotal sheets 112 are inwardly pivoted, the diffuser 3 is locked on the bottom of the illuminator 1. When the multiple pivotal sheets 112 are outwardly pivoted, the diffuser 3 is detached for replacing another diffuser 3 having different curvature to provide a different projecting area.

Although the invention has been explained in relation to its preferred embodiment, it is to be understood that many other possible modifications and variations can be made without departing from the spirit and scope of the invention as hereinafter claimed.

What is claimed is:

1. A table lamp with an adjustable projecting area comprising:
an illuminator, the illuminator having a diffuser detachably mounted on one side thereof and at least one fastening means disposed thereon corresponding to the diffuser for selectively fastening the diffuser on the illuminator; and
at least one lamp received in the illuminator for emitting lights, the at least one lamp provided for a spotlighting function, the at last one lamp covered by the diffuser;
wherein the lights emitted by the at least lamp are diffused by the diffuser for changing a projecting area to suit different environment; the diffuser is detachable and is replaced with different diffusers such that projecting area is adjustable.

2. The table lamp with an adjustable projecting area as claimed in claim 1, wherein the at least one fastening means are two dove-tail grooves respectively defined in two ends of the illuminator for slidably receiving the diffuser, the two dove-tail groove being parallel to each other.

3. The table lamp with an adjustable projecting area as claimed in claim 1, wherein the at least one fasten means are multiple pivotal sheets respectively pivotally mounted on edges of the illuminator for pivotally locking the diffuser.

4. The table lamp with an adjustable projecting area as claimed in claim 1, wherein the diffuser has multiple optical protrusions formed on a side thereof opposite to at least one the lamps, the multiple optical protrusions being pervious, the multiple optical protrusions provided for refracting the lights emitted by the at least one lamp.

5. The table lamp with an adjustable projecting area as claimed in claim 1, wherein the diffuser has a scattering layer formed thereon, the scattering layer being pervious, the scatting layer having multiple optical particles formed therein for uniformly diffusing lights emitted by the at least lamp.

6. The table lamp with an adjustable projecting area as claimed in claim 4, wherein the diffuser has a scattering layer formed thereon, the scattering layer being pervious, the scatting layer having multiple optical particles formed therein for uniformly diffusing lights emitted by the at least lamp toward the multiple optical protrusions.

7. The table lamp with an adjustable projecting area as claimed in claim 1, wherein the at least lamp is a LED.

8. The table lamp with an adjustable projecting area as claimed in claim 1, wherein the at least lamp is a RGB LED.

9. The table lamp with an adjustable projecting area as claimed in claim 1, wherein the at least lamp is a white LED.

10. The table lamp with an adjustable projecting area as claimed in claim 1, wherein the at least lamp is a color temperature LED provided for emitting lights having different color temperatures.
